(19) United States
(12) Patent Application Publication
(10) Pub. No.: US 2022/0067090 A1
(43) Pub. Date: Mar. 3, 2022

(54) SYSTEMS, METHODS, AND APPARATUSES FOR INTELLIGENT AUDIO EVENT DETECTION

(71) Applicant: Comcast Cable Communications, LLC, Philadelphia, PA (US)

(72) Inventors: Navdeep Jain, Philadelphia, PA (US); HongCheng Wang, Arlington, VA (US); Rui Min, Vienna, VA (US)

(21) Appl. No.: 17/006,011

(22) Filed: Aug. 28, 2020

(51) Int. Cl. G06F 16/687; G06F 16/68; G06F 16/783; G06F 16/65

(52) U.S. Cl. CPC G06F 16/687; G06F 16/65; G06F 16/7834; G06F 16/686

(57) ABSTRACT

Methods, systems, and apparatuses for intelligent audio event detection are described herein. Audio data and video data from a sensor is analyzed. The audio data may include an audio event of interest that is associated with a confidence level. The confidence level may be adjusted based on a location of the sensor and context data associated with the audio event. Notifications may be sent based on the adjusted confidence level and the context data.

### BACKGROUND

Interpretation of audio captured by a sensor (e.g., camera) enables the generation of user notifications based on interpretation of audio events. As the amount of information being monitored via sensors has increased, the burden of generating pertinent notifications to users of a monitoring sensor has increased. Many different types of sounds may be sensed by the monitoring sensor. The quantity of different types of sounds being monitored increases the complexity of classifying captured audio at a high confidence level. These and other considerations are addressed herein.

### SUMMARY

It is to be understood that both the following general description and the following detailed description are exemplary and explanatory only and are not restrictive, as claimed. Methods, systems, and apparatuses for audio event detection are described herein. A sensor may be configured to capture audio comprising an audio event. The audio event may be classified (e.g., identified). A context of the audio event may also be determined and used for classification. The context may be associated with the location of the sensor. The context may be used to adjust a confidence level associated with the classification of the audio event. One or more actions may be initiated based on the confidence level (e.g., a notification).

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example environment in which the present methods and systems may operate;

FIG. 2 shows an example analysis module;

FIG. 3 shows an environment in which the present methods and systems may operate;

FIG. 4 shows a flowchart of an example method;

FIG. 5 shows a flowchart of an example method;

FIG. 6 shows a flowchart of an example method; and

FIG. 7 shows a block diagram of an example computing device in which the present methods and systems may operate.

### DETAILED DESCRIPTION

Before the present methods and systems are described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Described are components that may be used to perform the described methods and systems. These and other components are described herein, and it is understood that when combinations, subsets, interactions, groups, etc. of these components are described that while specific reference of each various individual and collective combinations and permutation of these may not be explicitly described, each is specifically contemplated and described herein, for all methods and systems. This applies to all aspects of this application including, but not limited to, steps in described methods. Thus, if there are a variety of additional steps that may be performed it is understood that each of these additional steps may be performed with any specific embodiment or combination of embodiments of the described methods.

The present methods and systems may be understood more readily by reference to the following detailed description and the examples included therein and to the Figures and their previous and following description. As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, flash memory internal or removable, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

Methods, systems, and apparatuses for intelligent audio event detection are described herein. There are different types of sounds that occur inside and outside a premises (e.g., a residential home). These different types of sounds may have audio frequencies that overlap with audio frequencies of audio events of interest. The audio events of interest may include events such as a smoke alarm, glass breaking, a gunshot, a baby crying, a dog barking, and/or the like. Audio events of interest may be associated with a premises monitoring function, a premises security function, an information gathering function and/or the like. Overlapping sounds may cause incorrect identification of audio events of interest. For example, false detections are possible due to environmental noise. For audio events of interest occurring within a particular scene, context information and other relevant information such as a location of a sensor that is used to detect the audio events of interest may be used to reduce incorrect identification of detected audio events of interest. The sensor may be used to recognize a scene in the premises. Based on this recognition, scene context information, and/or the location of the sensor, a confidence level of a classification of a detected audio event of interest may be determined or adjusted. For example, the sensor may be located outside the premises and scene context may indicate that a family living at the premises should have temporarily left the premises (e.g., based on time of day), so a baby cry audio event detected by the sensor may be determined to be a false detection. A confidence level that the baby cry audio event is accurately classified as the baby cry audio event may be decreased based on the location of the sensor and the scene context information.

The sensor may be used to sense information in an environment, such as a given scene monitored by the sensor. The sensor may include one or more sensors such as an audio sensor and a video sensor. The information may be audio data and video data associated with an audio event of interest. The sensor may perform processing of the audio data and the video data. For example, an analysis module (e.g., audio and video analysis module) may perform machine learning and feature extraction to identify an audio event of interest associated with a given scene monitored by the sensor. For example, the analysis module may perform an audio signal processing algorithm and/or an audio signal processing algorithm to determine context information associated with the given scene, a confidence level indicative of an accuracy of a classification of the audio event of interest, and the location of the sensor. The sensor may communicate, via an access point or directly, with another sensor and/or a computing device. The computing device may be located on the premises or located remotely to the premises. The computing device may receive the audio data and video data from the sensor. Based on the received data, the computing device may determine the context information, the sensor location, and the confidence level. Based on this determination, the computing device may perform an appropriate action, such as sending a notification to a user device.

The computing device and/or the sensor may perform feature extraction and machine learning to analyze the data output by the sensors. For example, the sensor may be a camera that may perform feature extraction and machine learning. The analyzed data (or raw data) may be used by a context server or context module to execute algorithms for determining context associated with a detected audio event. In this way, the context server may determine context data and/or to dynamically set one or more of a confidence level threshold or relevancy threshold. For example, the distance between the sensor and an object (e.g., a burning object) associated with an audio event of interest may be used to set the relevancy threshold (e.g., threshold distance) at which a user notification (e.g., fire alarm) is triggered. The context server may determine or adjust confidence level based on the determined context and the location of the sensor. For example, the confidence level may be increased based on relevant context information and the sensor location. A notification may be sent to a user device based on the confidence level and/or context information. For example, a notification may be sent based on the confidence level satisfying a threshold and/or the context or relevant information satisfying the threshold. For example, a notification may be sent based on context information indication that a threshold volume has been reached (e.g, a volume of a baby crying sound or a dog barking sound exceeds a threshold).

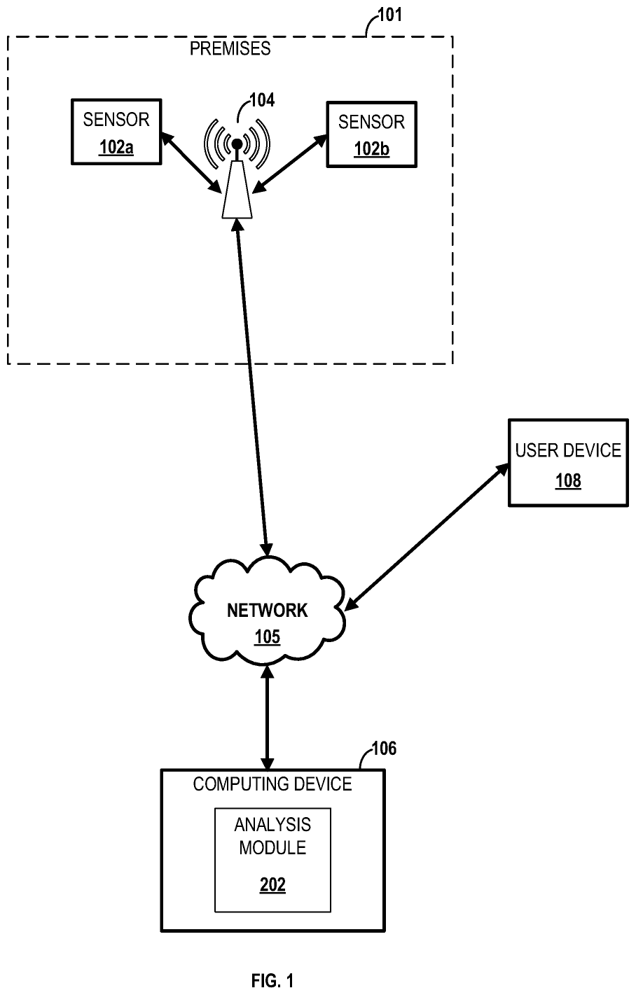

FIG. 1 shows an environment in which the present methods and systems may operate. The environment is relevant to systems and methods for detecting and classifying audio events within a scene monitored by at least one sensor. A premises 101 may be monitored by the at least one sensor. The premises 101 may be a residential home, commercial building, outdoor area, park, market, other suitable place being monitored, combinations thereof, and/or the like. The at least one sensor may include a first sensor 102a and/or a second sensor 102b. Sensors 102a, 102b may comprise, for example, an audio sensor and/or a video sensor. The audio sensor may be, for example, a microphone, transducer, or other sound detection device. The audio sensor may generate or output audio data from which audio feature extraction is performed for sound classification. The video sensor may be, for example, a three dimensional (3D) camera, a red green blue (RGB) camera, an infrared camera, a red green blue depth (RGBD) camera, a depth camera, combinations thereof, and the like. The video sensor may generate or output video data from which visual object detection is performed to identify objects of interest. The at least one sensor may comprise other types of sensors, for example, a light detection and ranging (LIDAR) sensor, a radar sensor, an ultrasonic sensor, a temperature sensor, or a light sensor.

The sensors 102a, 102b may capture information about an environment such as the premises 101. The information may be sound information, a visual object, an amount of light, distance information, temperature information, and/or the like. For example, the audio sensor may detect a baby crying sound within the premises 101. The sensors 102a, 102b may output data that may be analyzed to determine a location of the sensors 102a, 102b as well as to determine context information and other relevant information about a scene within the premises 101. For example, the location of the sensors 102a, 102b may be labeled as a nursery within the premises 101 such that if the nursery located sensors 102a, 102b detect the baby crying sound, a confidence level that the sound is accurately classified as a baby crying is increased. The locations of the sensor 102a, 102b also may be received from an external source. For example, a user may manually input the location of the sensor. The user may label or tag the sensor 102a, 102b with a location such as a portion of the premises 101 such as a dining room, bedroom, nursery room, child's room, garage, driveway, or patio, for example. The sensors 102a, 102b may be portable such that the location of the sensors 102a, 102b may change. The sensors 102a, 102b may comprise an input module to process and output sensor data, such as audio feed and video frames. The input module may be used to capture one or more images (e.g., video, etc.) and/or audio of a scene within its field of view.

The sensors 102a, 102b may each be associated with a device identifier. The device identifier may be any identifier, token, character, string, or the like, for differentiating one sensor (e.g., the sensor 102a) from another sensor (e.g., the sensor 102b). The device identifier may also be used to differentiate the sensors 102a, 102b from other sensors, such as those located in a different house or building. The device identifier may identify a sensor as belonging to a particular class of sensors. The device identifier may be information relating to or associated with the sensors 102a, 102b such as a manufacturer, a model or type of device, a service provider, a state of the sensors 102a, 102b, a locator, a label, and/or a classifier. Other information may be represented by the device identifier. The device identifier may include an address element (e.g., interne protocol address, a network address, a media access control (MAC) address, an Internet address) and a service element (e.g., identification of a service provider or a class of service).

The sensor 102a and/or sensor 102b may be in communication with a computing device 106 via a network device 104. The network device 104 may comprise an access point (AP) to facilitate the connection of a device, such as the sensor 102a to a network 105. The network device 104 may be configured as a wireless access point (WAP). As another example, the network device 104 may be a dual band wireless access point. The network device 104 may be configured to allow one or more devices to connect to a wired and/or wireless network using Wi-Fi, BLUETOOTH®, or any desired method or standard. The network device 104 may be configured as a local area network (LAN). The network device 104 may be configured with a first service set identifier (SSID) (e.g., associated with a user network or private network) to function as a local network for a particular user or users. The network device 116 may be configured with a second service set identifier (SSID) (e.g., associated with a public/community network or a hidden network) to function as a secondary network or redundant network for connected communication devices. The network device 104 may have an identifier. The identifier may be or relate to an Internet Protocol (IP) Address IPV4/IPV6 or a media access control address (MAC address) or the like. The identifier may be a unique identifier for facilitating communications on the physical network segment. There may be one or more network devices 104. Each of the network devices 104 may have a distinct identifier. An identifier may be associated with a physical location of the network device 104.

The network device 104 may be in communication with a communication element of the sensors 102a, 102b. The communication element may provide an interface to a user to interact with the sensors 102a, 102b. The interface may facilitate presenting and/or receiving information to/from a user, such as a notification, confirmation, or the like associated with a classified/detected audio event of interest, a scene of the premises 101 (e.g., that the audio event occurs within), a region of interest (ROI), a detected object, or an action/motion within a field of view (e.g., including the scene) of the sensors 102a, 102b. The interface may be a communication interface such as a display screen, a touchscreen, an application interface, a web browser (e.g., Internet Explorer®, Mozilla Firefox®, Google Chrome®, Safari®) or the like. Other software, hardware, and/or interfaces may provide communication between the user and one or more of the sensors 102a, 102b and the computing device 106. The user may engage in this communication via a user device 108, for example. The sensors 102a, 102b may communicate over the network 105 via the network device 104. The sensors 102a, 102b may communicate with each other and with a remote device such as a computing device 106, via the network device 104, to send captured information. The captured information may be raw data or may be processed. The computing device 106 may be located at the premises 101 or remotely from the premises 101, for example. The captured information may be processed by the sensors 102a, 102b at the premises 101. There may be more than one computing device 106. Some of the functions performed by the computing device 106 may be performed by a local computing device (not shown) at the premises 101. The sensors 102a, 102b may communicate directly with the remote device, such as via a cellular network.

The computing device 106 may be a personal computer, portable computer, camera, smartphone, server, network computer, cloud computing device and/or the like. The computing device 106 may comprise one or more servers including a context server and a notification server for communicating with the sensors 102a, 102b. The sensors 102a, 102b and the computing device 106 may be in communication via a private and/or public network 105 such as the Internet or a local area network. Other forms of communications may be used such as wired and wireless telecommunication channels. The computing device 106 may be disposed locally or remotely relative to the sensors 102a, 102b. For example, the computing device 106 may be located at the premises 101. For example, the computing device 106 may be part of a device containing the sensors 102a, 102b or a component of the sensors 102a, 102b. As another example, the computing device 106 may be a cloud based computing service, such as a remotely located computing device 106 in communication with the sensors 102a, 102b via the network 105 so that the sensors 102a, 102b may interact with remote resources such as data, devices, and files. The computing device 106 may communicate with the user device 108 for providing data and/or services related to detection and classification of audio events of interest. The computing device 106 may also provide information relating to visual events, detected objects and other events of interest within a field of view or a region of interest (ROI) of the sensors 102a, 102b to the user device 108. The computing device 106 may provide services such as context detection, location detection, analysis of audio event detection and classification, and/or the like.

The computing device 106 may manage the communication between the sensors 102a, 102b and a database for sending and receiving data therebetween. The database may store a plurality of files (e.g., detected and classified audio events of interest, audio classes, location of the sensors of the sensors 102a, 102b, detected objects, scene classifications, ROIs, user notification preferences, thresholds, audio source identifications, motion indication parameters, etc.), object and/or action/motion detection algorithms, or any other information. The sensors 102a, 102b may request and/or retrieve a file from the database, such as to facilitate audio feature extraction, video frame analysis, execution of a machine learning algorithm, and the like. The computing device 106 may retrieve or store information from the database or vice versa. The computing device 106 may obtain extracted audio features, initial classifications of audio events of interest, video frames, ROIs, detected objects, scene and motion indication parameters, location and distance parameters, analysis resulting from machine learning algorithms, and the like from the sensors 102a, 102b. The computing device 106 may use this information to determine context information, the location of the sensors 102a, 102b, send notifications to a user, as well as for other related functions and the like.

The computing device 106 may comprise an analysis module 202. The analysis module 202 may be configured to receive data from the sensors 102a, 102b, perform determinations such as classifying an audio event of interest, determining context information, and determining a confidence level associated with the classification of the audio event of interest, and taking appropriate action based on these determinations. For example, for a baby cry audio event of interest, the analysis module 202 may check and determine that the location of the sensors 102a, 102b detecting the baby cry audio event of interest to be at an outdoor patio of the premises 101. Based on the outdoor patio location, the confidence level that the audio event of interest is accurately classified as a baby crying is decreased. The analysis module 202 may determine context information such as the absence of a baby in a family living at the premises 101, such as based on object detection performed from video data from the sensors 102a, 102b. As another example, the location of the sensors 102a, 102b may be determined by the analysis module 202 as a baby's room and a baby may be seen and recognized in video data from the sensors 102a, 102b via object detection by the analysis module 202. Based on this determination and recognition, the confidence level that the audio event of interest is accurately classified as a baby crying is increased.

The analysis module 202 may be configured to perform audio/video processing and/or implement one or more machine learning algorithms with respect to audio events. For example, the analysis module 202 may perform an audio signal processing algorithm to extract properties (e.g., audio features) of an audio signal to perform pattern recognition, classification (e.g., including how the audio signal compares or correlates to other signals), and behavioral prediction. As another example, the analysis module 202 may perform these audio processing and machine learning algorithms in conjunction with the sensors 102a, 102b. For example, for object detection, the sensors 102a, 102b may perform minimal work such as detecting a region of interest or bounding boxes in a scene and sending this information to the analysis module 202 to perform further cloud-based processing that detects the actual object. As another example, the computing device 106 may receive the results of these audio processing and machine learning algorithms performed by the sensors 102a, 102b.

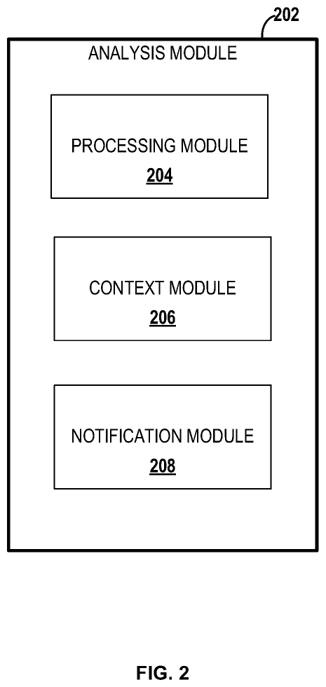

FIG. 2 shows the analysis module 202. The analysis module 202 may comprise a processing module 204, a context module 206, and a notification module 208. In an embodiment, each module may be contained on a single computing device, or may be contained on one or more other computing devices. The processing module 204 may be used to perform audio processing and/or implement one or more machine learning algorithms to analyze an audio event of interest and video data. The processing module 204 may be in communication with the sensors 102a, 102b in order to receive audio data and/or video data from the sensors 102a, 102b. The context module 206 may reside on a separate context server. The context module 206 may perform various algorithms (e.g., machine learning and audio processing algorithms) to identify the location of the sensors 102a, 102b (e.g., a driveway, bedroom, kitchen of a house, and the like relative to the premises 101) and identify the context of the scene. The location may be indicated by geographical coordinates such as Global Positioning System (GPS) coordinates, geographical partitions or regions, location labels, and the like. The notification module 208 may determine whether to notify a user (e.g, via the user device 108) based on confidence level threshold(s) and relevancy threshold(s). The notification module 208 may reside on a separate notification server.

Analysis of an audio event of interest may involve one or more machine learning algorithms. A machine learning algorithm may be integrated as part of audio signal processing to analyze an extracted audio feature, such as to determine properties, patterns, classifications, correlations, and the like of the extracted audio signal. The machine learning algorithm may be performed by the computing device 106, such as by the analysis module 202 of the computing device 106. For example, the analysis module 202 may determine sound attributes such as the waveform associated with the audio, pitch, amplitude, decibel level, intensity, class, and/or the like. As another example, the analysis module 202 may detect specific volumes or frequencies of sounds of a certain classification, such as a smoke alarm. The analysis module 202 may also decode and process one or more video frames in video data to recognize objects of interest, and process audio data to recognize the events of interest. Video based detection of objects and audio based event detection may involve feature extraction, convolutional neural networks, memory networks, and/or the like. In this way, video frames having objects of interest may be determined, and the audio samples having events of interest may be determined.

The analysis module 202 may identify a source and a type of an audio event of interest. Such an identification may be an initial identification of the detected audio event of interest which may be further interpreted by the computing device 106 based on context information and the location of the sensors 102a, 102b. For example, the computing device 106 may determine or adjust a confidence level (e.g., adjust an initial confidence level determined by and/or in conjunction with the sensors 102a, 102b). The identification or classification of the analysis module 202 may be based on a comparison or correlation with an audio signature stored in a database. Audio signatures may be stored based on context information (e.g., including the location of the sensors 102a, 102b) determined by the computing device 106. Audio signatures may define a frequency signature such a high frequency signature or a low frequency signature; a volume signature such as a high amplitude signature or a low amplitude signature; a linearity signature such as an acoustic nonlinear parameter; and/or the like. The analysis module 202 may also analyze video frames of the generated video data for object detection and recognition. The sensors 102a, 102b may send audio events of interest and detected objects of interest and/or associated audio samples and/or one or more video frames to the computing device 106 (e.g., the analysis module 202). Corresponding analysis by the sensors 102a, 102b may also be sent to the computing device 106 or such analysis may be performed by analysis module 202.

Other sensor data may be received and analyzed by the analysis module 202. A depth camera of the sensors 102a, 102b may determine a location of the sensors 102a, 102b based on emitting infrared radiation, for example. The location of the sensors 102a, 102b may also be determined based on information input by a user or received from a user device (e.g., mobile phone or computing device). The location of the sensors 102a, 102b also may be determined via a machine learning classifier, neural network, or the like. The analysis module 202 may use the machine learning classifier to execute a machine learning algorithm. For example, a machine learning classifier may be trained on scene training data to label scenes or ROIs, such as those including video frames having audio events of interest or objects of interest. For example, the classifier may be trained to classify the sensors 102a, 102b as being located in a patio, garage, living room, kitchen, outdoor balcony, and the like based on identification of objects in a scene that correspond to objects typically found at those locations. The machine learning classifier may use context information with or without sensor data to determine the location of the sensors 102a, 102b. The sensors 102a, 102b may be moved to other places, such as by a user moving their portable sensors 102a, 102b to monitor a different location. In such a scenario, the computing device 106 may determine that the location of the sensors 102a, 102b has changed and trigger a new determination of the location.

The processing module 204 may be in communication with the sensors 102a, 102b to perform audio feature extraction and implement a machine learning algorithm to identify audio events of interest within an audio feed. The processing module 204 may determine a source of sound within the audio feed as well as recognize a type of sound (e.g., identify a class of the audio). The class of audio may be a materials class identifying a type of material such as a glass breaking sound or a vacuum operation sound; a location class such as a kitchen sound (e.g., clanking of a pot or pan) or bathroom sound (e.g., toilet flushing); a human class such as sounds made by humans (e.g., baby crying, yelling sound, human conversation); and/or the like. The processing module 204 may also perform basic object recognition, such as a preliminary identification of an object based on video data from the sensors 102a, 102b. The processing module 204 may determine a preliminary confidence level or a correlation indicative of how likely the detected audio event actually corresponds to the recognized type or class of audio. For example, a class of audio or sound may be audio related to a pet in a house, such as a dog (e.g., dog barking, dog whining, and the like). The preliminary confidence level or correlation can be analyzed and evaluated by the context module 206 based on context information, location of the sensors 102a, 102b, and other relevant information. For example, the context module 206 may determine context information to analyze the preliminary confidence level or correlation determined by the processing module 204. For example, the processing module 204 may identify the presence of a dog or a dog barking audio event of interest with a preliminary confidence level and the context module 206 may determine context information such as a time of day, a presence of dog treats, and a location of the sensors 102a, 102b detecting the dog barking audio event of interest to adjust (e.g., increase or decrease) the preliminary confidence level.

The processing module 204 may analyze one or more images (e.g., video, frames of video, etc.) determined/captured by the sensors 102a, 102b and determine a plurality of portions of a scene within a field of view of the sensors 102a, 102b (e.g., the input module 111). Each portion of the plurality of portions of the scene may be classified/designated as a region of interest (ROI). A plurality of ROIs associated with a scene may be used to generate a region segmentation map of the scene. The processing module 204 may use a region segmentation map as baseline and/or general information for identifying objects, audio, and the like, of a new scene in a field of view of the sensors 102a, 102b. For example, the processing module 204 may determine the presence of a car and the context module 206 may determine, based on the car, that the sensors 102a, 102b are monitoring a scene of a garage in a house (e.g., the premises 101) with an open door and the car contained within the garage. The information generated by the processing module 204 may be used by the context module 206 to determine context and location of detected audio events of interest to interpret classified or detected audio, such as by adjusting the preliminary confidence level. The notification module 208 may compare the adjusted confidence level to a threshold and compare the determined context to relevancy criteria or thresholds. One or more functions performed by the processing module 204 may instead performed by or in conjunction with the context module 206, the notification module 208, or the sensors 102a, 102b.

The processing module 204 may use selected and/or user provided information (e.g., via the user device 108) or data associated with one or more scenes to automatically determine a plurality of portions (e.g., ROIs) of any scene within a field of view of the sensors 102a, 102b. The selected and/or user provided information may be provided to the sensors 102a, 102b during a training/registration procedure. A user may provide general geometric and/or topological information/data (e.g., user defined regions of interest, user defined geometric and/or topological labels associated with one or more scenes such as “street,” “bedroom,” “lawn,” etc.) to the sensors 102a, 102b. The user device 108 may display a scene in the field of view of the sensors 102a, 102b. The user device 108 may use the communication element (e.g., an interface, a touchscreen, a keyboard, a mouse, etc.) to generate/provide the geometric and/or topological information/data to the computing device 106. The user may use an interface to identify (e.g., draw, click, circle, etc.) regions of interests (ROIs) within a scene. The user may tag the ROIs with labels such as, “street,” “sidewalk,” “private walkway,” “private driveway,” “private lawn,” “private living room,” and the like. A region segmentation map may be generated, based on the user defined ROIs. One or more region segmentation maps may be used to train a camera system (e.g., a camera-based neural network, etc.) to automatically identify/detect regions of interest (ROIs) within a field of view. The processing module 204 may use the general geometric and/or topological information/data (e.g., one or more region segmentation maps, etc.) as template and/or general information to predict/determine portions and/or regions of interest (e.g., a street, a porch, a lawn, etc.) associated with any scene (e.g., a new scene) in a field of view of the sensors 102a, 102b.

The processing module 204 may determine an area within its field of view to be a ROI (e.g., a region of interest to a user) and/or areas within its field of view that are not regions of interest (e.g., non-ROIs). The processing module 204 may determine an area within its field of view to be a ROI or non-ROI based on long-term analysis of events occurring within its field of view. The processing module 204 may determine/detect a motion event occurring within an area within its field of view and/or a determined ROI, such as a person walking towards a front door of the premises 101 within the field of view of the sensors 102a, 102b. The processing module 204 may analyze video captured by the sensors 102a, 102b (e.g., video captured over a period of time, etc.) and determine whether a plurality of pixels associated with a frame of the video is different from a corresponding plurality of pixels associated with a previous frame of the video. The processing module 204 may tag the frame with a motion indication parameter based on the determination whether the plurality of pixels associated with the frame is different from a corresponding plurality of pixels associated with a previous frame of the video. If a change in the plurality of pixels associated with the frame is determined, the frame may be tagged with a motion indication parameter with a predefined value (e.g., 1) at the location in the frame where the change of pixel occurred. If it is determined that no pixels changed (e.g., the pixel and its corresponding pixel is the same, etc.), the frame may be tagged with a motion indication parameter with a different predefined value (e.g., 0). A plurality of frames associated with the video may be determined. The processing module 204 may determine and/or store a plurality of motion indication parameters.

A determination of context information and a location of the sensors 102a, 102b can be performed by the context module 206 of the computing device 106. The context module 206 may perform various algorithms to determine context information. The context module 206 (e.g., context server) may execute a scene classification algorithm to identify the location of the sensors 102a, 102b. The context module 206 may execute other algorithms including an object detector algorithm, an activity detection algorithm, a distance identifier algorithm, an audio source separation algorithm, and the like. The context module 206 may be an independent computing device. The context module 206 may receive extracted audio features and video frames of the output video to determine context information of or associated with the scene monitored by the sensors 102a, 102b as well as to determine a location of the sensors 102a, 102b. For example, the context module 206 may use depth sensor data to determine the location of the sensors 102a, 102b. The context module 206 may determine context data based on or associated with a result of processing, performed by processing module 204, on audio data and video data from the sensors 102a, 102b. One or more functions performed by the context module 206 may instead performed by or in conjunction with the processing module 204, the notification module 208, or the sensors 102a, 102b.

As another example, the context module 206 may determine the location of the sensors 102a, 102b based on periodically executing a scene classification. As another example, the context server may perform a deep learning based algorithm to determine or identify the distance of an audio source from the sensors 102a, 102b. Context generation may also be performed by the sensors 102a, 102b or an edge device. The context module 206 may perform various machine learning algorithms and/or audio signal processing instead of or in addition to the algorithms executed by the sensors 102a, 102b. The context module 206 may use the video frames as an input to perform an object detector algorithm to identify objects of interest within the monitored scene. The objects of interest may be the source of or be related to an audio event of interest that is determined based on the executed audio signal processing algorithm. The context module 206 may determine a confidence level of classification of the audio event of interest (e.g., based on a preliminary processing of the audio event of interest performed by the processing module 204) to assess the accuracy of the classification of the audio event of interest. The determined confidence level may be generally indicative of the accuracy or may yield a numerical indication of how accurate the classification is, for example. This determination may be part of executing a machine learning algorithm. The context module 206 may identify changes in context. When the context changes, a trigger may occur such that the context module 206 re-determines context and identifies the change to the new context.

A scene classification algorithm executed by the context module 206 may be based on various input variables. The values of these input variable may be determined based on sensing data from the sensors 102a, 102b. For example, temperature sensed by a temperature sensor of the sensors 102a, 102b may be used as an input variable so the machine learning classifier infers that the scene is classified as a mechanical room of a building and that the sensors 102a, 102b is located next to a ventilation unit (e.g., based on data from a depth sensor such as a 3D-RGB camera, RGB-D sensor, LIDAR sensor, radar sensor, or ultrasonic sensor). As another example, the context server 208 may infer the sensors 102a, 102b are located in a parking garage scene based on the sound associated with a garage door opening, object recognition of multiple cars in the video frames of the scene, sensed lighting conditions, and the like. Determination of context based on execution of the scene classification algorithm may include granular determinations. For example, the context module 206 may detect the presence of an electric car based on classifying a low electrical hum as electrical car engine noise and visually recognizing an object as a large electrical plug in a classified scene of a home parking garage. In this example, this context information determined by the context module 206 may be used to disable notifications associated with gasoline car ignition noises that are inferred to be from a neighbor's house (e.g., based on using a depth camera to determine the distance between the source of the car ignition noises and the sensors 102a, 102b).

The context module 206 may execute one or more algorithms (e.g., machine learning algorithms) as part of determining context information. For example, the context module 206 may execute an object detector algorithm, an activity detector algorithm, a distance identifier algorithm, an audio source separation algorithm, and the like. Executing the object detector algorithm may involve identifying objects in a scene, field of view, or ROI monitored by the sensors 102a, 102b. Such objects may be semantically identified as a dog, cat, a person (which may include the specific identity/name of the person), and the like, for example. The object detection may involve analysis of video frames received from the sensors 102a, 102b to recognize objects via a convolution operation, Region-based Convolutional Neural Network (R-CNN) operation, or the like, for example. Details associated with recognized objects of interest may be stored in the database. The context module 206 may determine long term context information, such as the people who typically appear in a monitored scene (e.g., a family member in a room of the family's residence). Long term context information may involve determination of historical trends, such as the number of times a baby cries or the frequency of turning on lights in the premises 101, for example.

The context module 206 may execute the activity detector algorithm to identify activity occurring during one or more detected audio events of interest. This activity detector algorithm may involve detecting voices or speech segments of interest (e.g., a person speaking versus background noise) by comparing pre-processed audio signals to audio signatures (e.g., stored in the database). For example, audio source-related features (e.g., Cepstral Peak Prominence), filter-based features (e.g., perceptual Linear Prediction coefficients, neural networks (e.g., an artificial neural network based classifier trained on a multi-condition database) and/or a combination thereof may be used. The activity detector algorithm may be used as part of context data and used to influence user notification or alert settings. For example, context information may include evaluating whether the person corresponding to voice audio of interest is an intruder or unknown person, whether the pitch or volume of voice audio of interest indicates distress, and the like.

The context module 206 may execute the distance identifier algorithm to identify a distance between a source of an audio event of interest and the determined location of the sensors 102a, 102b. This distance may be estimated visually or audibly via data from the sensors 102a, 102b. The distance may be determined with a depth sensor (e.g., 3D-RGB camera, radar sensor, ultrasonic sensor or the like) of the sensors 102a, 102b. The context module 206 may receive the location of the source of the audio event of interest from the sensors 102a, 102b, such as based on analysis of its attributes by the sensors 102a, 102b, or the processing module 204 and/or context module 206 may determine the source location. Based on measurements to the source of the audio event of interest made via the depth sensor, the context module 206 may determine whether the origin of the audio event of interest is in a near-field ROI/field of view, or a far-field ROI/field of view. Depending on the distance and other context information, the context module 206 may interpret or adjust interpretation of the audio event of interest. For example, the audio event of interest could be an event identified as a far-field smoke alarm (e.g., the sensors 102a, 102b determine that the identified event has a low sound intensity) and the location could be a bathroom with no detected flammable objects (e.g., based on video object detection) such that the context module 206 may infer based on the context information and location of the sensors 102a, 102b that the audio event of interest should not be classified as a smoke alarm because it may be a sound originating from another location such as a neighboring house, rather than the bathroom. As another example, the context module 206 may analyze data output by the 3D-RGB camera to detect where and how far away a crying baby is and determine whether the crying baby audio event is a near-field event.

The context module 206 may execute an audio source separation algorithm to separate different audio present in the audio data and/or extracted audio features received from the audio sensor 202. Various audio events identified in the audio data may have different origin sources, although some audio events could share the same source (e.g., a dog is the source of both dog barking noise and dog whining noises). Execution of the audio source separation algorithm may involve blind source separation, for example, to separate mixture of multiple audio sources. For example, a combined audio event can be separated into a knocking sound resulting from someone knocking on a door and a dog barking from a dog. The separate audio sources may be analyzed separately by the context module 206. The context module 206 may determine or set certain thresholds, such as a context detection threshold. This threshold may be dynamically set. For example, the context module 206 may determine a maximum threshold of 1000 feet for object detection. That is, static objects or audio events detected to be more than 1000 feet away from the sensors 102a, 102b could be ignored, such as for the purposes of generating a user notification. For example, a fire alarm device emitting sounds from more than 1000 feet away may be disregarded. Temperature data from a temperature sensor of the sensors 102a, 102b may also be assessed to confirm whether a fire exists in the monitored scene, field of view or ROI.

The context module 206 may determine a periodic time parameter such as a time of the day of an event, season of the year (e.g., winter), and the like. The periodic time parameter may be used to determine context information and inferences based on context such as how many people would typically be present in a house at a particular time, whether a baby would normally be sleeping at a particular time of day, that a snowblower sound should not be heard during the summer, and the like. Such inferences may be used by the computing device 106 or notification module 208 to manage user notifications. At least a portion of the algorithms executed by the context module 206 alternatively may be executed by the sensors 102a, 102b. The context server 208 may be part of a computing device 106 located at the premises 101 or be part of a computing device 106 located remotely, such as part of a remote cloud computing system. The context module 206 may generate context metadata based on various algorithms such as those described herein and the like. This context metadata may be stored in the database and/or sent to the notification module 208 of the computing device 106.

The context module 206 may determine when context of a scene, field of view, or ROI monitored by the sensors 102a, 102b has changed. For example, the sensors 102a, 102b may be moved from an outdoor environment to an indoor environment. The context module 206 may automatically detect that the context has changed. For example, an accelerometer of the sensors 102a, 102b may detect that the location of the sensors 102a, 102b has changed such that the context module 206 re-executes the scene classification algorithm to determine the changed/new context. As another example, the context module 206 re-executes the scene classification algorithm when there is device power-off and power-on (e.g., of the sensors 102a, 102b). As another example, the context module 206 may periodically analyze the context to determine whether any changes have occurred. The context module 206 may use current context information and changed context information to adjust a confidence level (e.g., a preliminary confidence level from the processing module 204) that an audio event of interest detected by the sensors 102a, 102b is accurately classified. The adjusted confidence level may be more indicative (e.g., relative to the preliminary confidence level) of the accuracy or may yield a numerical indication of how accurate the classification is, for example.

Detected changes in context may generate a notification to the user device 108. The notification module 208 may determine whether a notification should be sent to the user device 108 based on context information, changes in context, location of the sensors 102a, 102b, confidence thresholds or levels, relevancy thresholds or criteria, and/or the like. For example, the notification module 208 may determine whether a confidence level of a classification of an audio event of interest exceeds a confidence level threshold. The context module 206 may send detected context data and re-determined context data (e.g., upon identifying a change in context) to the notification module 208. The notification module 208 may be an independent computing device. The notification module 208 may receive the confidence level of the classification of the audio event of interest as determined by the context module 206. The notification module 208 may compare the received confidence level to a threshold to determine whether a user notification should be sent to the user device 108 or to determine a user notification setting (e.g., an indication of an urgency of an audio event of interest that the user is notified of, a frequency of how often to generate a user notification, an indication of whether or how much context information should be sent to the user device 108, and the like). The notification module 208 may compare the context information to a relevancy threshold or relevancy criteria to determine whether the user notification should be sent to the user device 108 or to determine the user notification setting.

The comparisons may be used so that the notification module 208 makes a binary determination of whether the user device 108 is to be notified of the audio event. The notification module 208 may send at least one appropriate notification to the user device 108, such as according to the comparisons and user notification settings. The comparisons may be based on the determined context and/or determined location of the sensors 102a, 102b. Also, the notification module 208 may independently determine the confidence level or adjusted confidence level based on the received audio features, identified audio, and identified objects of interest. The context module 206 and the notification module 208 may be part of a locally located computing device 106 (e.g., locally located at the premises 101) or a remotely located computing device 106. One or more functions performed by the notification module 208 may instead be performed by or in conjunction with the processing module 204, the context module 206, or the sensors 102a, 102b.

The notification module 208 may also determine whether a detected audio event of interest has a relevant context, such as by comparing the context data and/or location of the sensors 102a, 102b to a relevancy threshold. Based on at least one of the confidence level comparison and the relevancy comparison, the notification module 208 may make the binary determination of whether the user device 108 is to be notified of the audio event. For example, the notification module 208 may notify a user that a baby crying sound has been detected (e.g., with sufficiently high confidence) based on the comparison of the classification of the audio event of interest to the confidence level threshold and relevancy threshold. The baby crying sound notification may be sent to the user device 108 because the determined context involves a determination that the scene is a bedroom, the location of the sensors 102a, 102b is close to a crib, and the family living in the house containing the bedroom includes a baby, for example. That is, the confidence level comparison and the relevancy comparison inform the classification and interpretation of the detected audio event such that it is appropriate to notify the user device 108 of the recognized audio event. When notification is appropriate, the notification module 208 send an appropriate notification to the user device 108. The confidence level threshold and relevancy threshold may be determined by the notification module 208 or received by the notification module 208 (e.g., set according to a communication from the user device 208).

The initial classification of the audio event of interest may be received from the sensors 102a, 102b, although the audio classification could instead be received from the context module 206. The notification module 208 may determine that the user device 108 should be notified if the initial confidence level audio classification is higher than a confidence threshold. The confidence threshold may be determined based on the location of the sensors 102a, 102b and the context information determined by the context module 206. The comparison of the audio classification to the confidence threshold may involve determining an accuracy confidence level or adjusting the accuracy confidence level of the audio classification. For example, an audio event of interest may be classified as a dog barking noise based on corresponding feature extraction of audio data and subsequently changed based on comparison to a confidence threshold. The comparison may indicate that no dog has been detected in the monitored scene (e.g., based on video object detection) and no animals are present in the building corresponding to the monitored scene. In this way, the context and location of the sensors 102a, 102b can be used to interpret the audio based classification. The notification module 208 may preemptively disable dog barking notifications based on the comparison, context, and location. For example, the notification module 208 may suggest to the user device 108 that dog barking or animal-based notifications should be disabled to prevent the occurrence of false positives. A user may allow this disablement or instead enable dog barking notifications at the user device 108 if desired.

The user may generally use the user device 108 to choose what notifications to receive, such as specific types, frequencies, parameters and the like of such notifications. Such user preferences may be sent by the user device 108 to the notification module 208 or computing device 106. The notification module 208 may also compare the determined context associated with an audio event of interest to a relevancy threshold or criteria. For example, the notification module 208 may receive an audio classification of a car ignition noise. Comparison of the context associated with this car ignition audio event to the relevancy threshold may involve considering that no car has been visually recognized, from the video data, as being present in the scene and/or that the time of day does not correspond to a car being present (e.g., context information indicates that a car is not generally present in a home during daytime working hours or even that the family living in the home does not own a car). Based on this context, the notification module 208 may determine that the car ignition audio noise does not have a sufficiently relevant context to warrant generation of a user notification to the user device 108. Instead of failing to generate a user notification, the notification module 208 may instead use the relevancy threshold comparison to suggest different notification settings to the user device 108. For example, the notification module 208 may suggest that the user could select receiving all notifications of audio events of interests by the user device 108, but with a message indicating the likelihood of that a particular notification is relevant to the user. Similarly, the notification module 208 may send a message to the user device 108 indicating the results of the confidence threshold comparison.

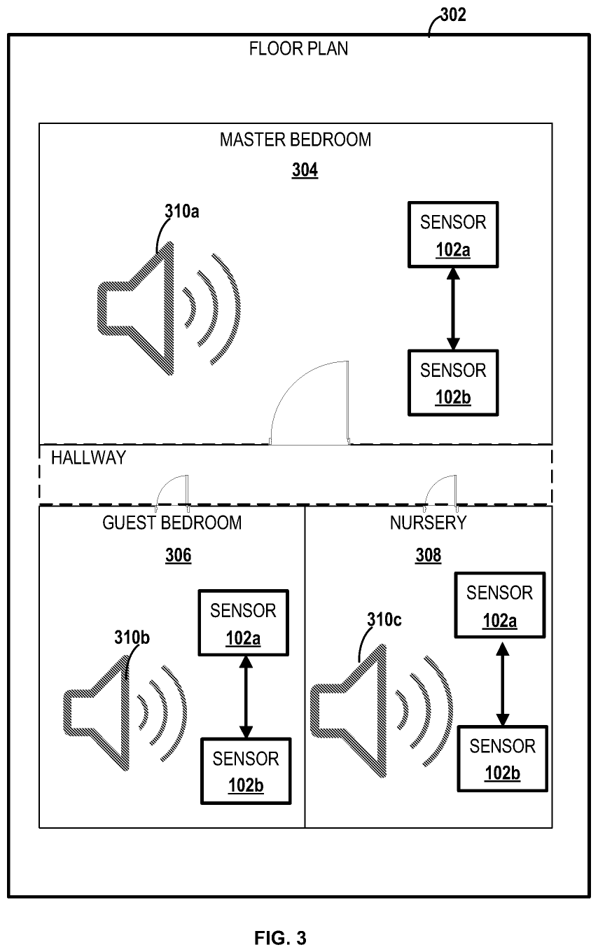

FIG. 3 shows an environment in which the present methods and systems may operate. A floor plan 302 of a given premises 101 is shown. The floor plan 302 indicates that the premises 101 comprises multiple rooms, including a master bedroom 304, a guest bedroom 306, and a nursery 308, for example. Sensors 102a, 102b may be placed in each of the rooms of the premises 101. Audio, noise, visual objects and/or the like may be monitored by the sensors 102a, 102b. In this way, the audio sensor 102a may output or generate audio data while the video sensor 102b may output or generate video data. The respective audible noises 310a, 310b, 310c may be monitored by the sensors 102a, 102b to determine whether a detected audio event of interest is relevant for the respective sensors 102a, 102b such as whether the detected audio event of interest is relevant for the particular location of the respective sensor 102a, 102b. For example, a dog barking noise of the noise 310c detected by the sensors 102a, 102b located in the nursery 308 may not be relevant to the location of the nursery 308 because no dogs are expected in the nursery or in the premises 101 (e.g., the family living in the premises 101 may not desire to allow any dogs near a baby resting in the nursery room 308). In this situation, the dog barking noise may be determined to be a false positive for the sensors 102a, 102b in the nursery. As another example, a glass breaking noise of the noise 310a detected by the sensors 102a, 102b located in the master bedroom 306 may be determined to be relevant because context information indicates that the master bedroom 306 contains a glass door or glass mirror (e.g., a bathroom minor, a glass door to a shower within the master bedroom 306, etc.). In this way, the accuracy of audio event recognition may be improved.

The analysis module 206 of either a locally located computing device 106 (e.g., located at the premises 101 or located as part of a device comprising sensors 102a, 102b) or a remotely located computing device 106 may execute audio feature extraction and one or more machine learning algorithms to identify audio events of interest within the respective audible noise 310a, 310b, 310c. The context module 206 may execute one or more algorithms (e.g., machine learning algorithms) as described herein as part of determining context information relevant to a scene monitored by 102a, 102b. The context module 206 may determine whether the context information and/or location of the respective sensors 102a, 102b is relevant to the respective audible noise 310a, 310b, 310c. This determination may be based on comparison of the context information and/or location of the respective sensors 102a, 102b to at least one threshold. Based on the comparison, a confidence level indicative of an accuracy of classification of an audio event of interest may be increased or decreased. The increased or decreased confidence level, context information, relevant information, location of the respective sensors 102a, 102b, results of the comparison and/or the like may be provided by the context module 206 to the notification module 206 so that the notification module 206 may determine whether to send a notification to the user device 108. The determination of whether to send a notification may be based on whether a notification threshold comparison is satisfied, the confidence level threshold comparison is satisfied, or some other notification criteria is met.

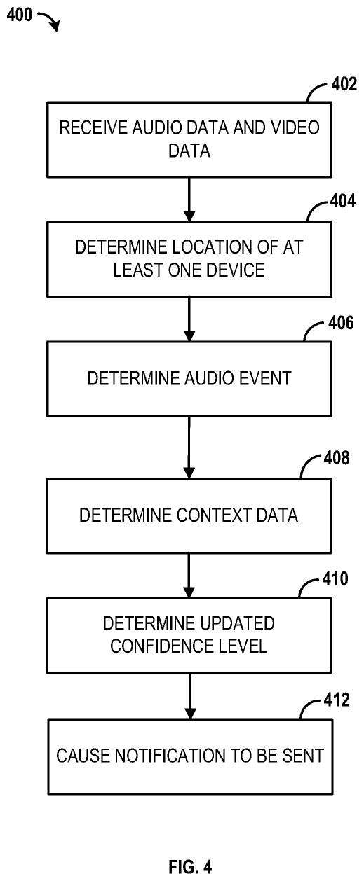

FIG. 4 shows a flowchart illustrating an example method 400 for intelligent audio event detection. The method 400 may be implemented using the devices shown in FIGS. 1-3. For example, the method 400 may be implemented using a context server such as the context module 206. At step 402, a computing device may receive audio data and video data. The audio data and video data may be received from at least one device. For example, the audio data may be received from an audio device such as the audio sensor 102a. As another example, the video data may be received from a video device such as the video sensor 102b. In this connection, video frames having recognized or detected objects may be received. Generally, the at least one device may comprise at least one of: of a microphone or camera. The audio data and video data may each be associated with a scene sensed by the at least one device. Audio features of interest within the audio data may be determined by an analysis module such as the analysis module 202 via performance of audio signal processing and machine learning algorithms. Determined properties, patterns, classifications and correlations of extracted audio features may be received by the computing device. As an example, an initial audio classification such as an audio classification at a preliminary confidence level may be received by the computing device.

At step 404, the computing device may determine a location of the at least one device. For example, the computing device may determine a location label of the at least one sensor during set up of the at least one device. The at least one device may be associated with at least one of: the audio data or the video data. The location may comprise a location of at least one of the sensors 102a, 102b. As an example, the location may be indicated by at least one of: GPS coordinates, a geographical region, or a location label. As an example, the location may be determined based on sensor data, machine learning classifiers, neural networks, and the like. As another example, the computing device may receive distance data from a depth camera (e.g., RGB-D sensor, LIDAR sensor, or a radar sensor). The computing device may determine the location of the at least one sensor based on this distance data. At step 406, the computing device may determine an audio event. The determination of the audio event may be based on the audio data and/or the video data. For example, the audio event may be classified based on audio feature extraction for sound classification and/or object recognition from the video data. The audio event may be determined with audio data alone. The audio event may be determined and analyzed based on audio data and video data together. For example, the video data may indicate the presence of a sleeping baby in a baby room via object detection and the audio data may indicate a dog barking audio event. The video data may be used to determine whether a notification of the detected audio event is a false positive, such as based on an inconsistency between an object detected in a scene using the video data and a characteristic and/or context of the detected audio event. For example, the indication of the presence of the baby may be used as context information to determine that the dog barking noise is probably a false positive because it is unlikely that a dog would be present in the same room as a sleeping baby. The audio event may be associated with a confidence level. The computing device may determine a time corresponding to the audio event. The computing device may determine a likelihood that the audio event of interest corresponds to a sound associated with the location.

At step 408, the computing device may determine context data associated with the audio event of interest. For example, the computing device may be a context module 206 that may perform various algorithms to determine the context data. The context module 206 may perform various algorithms (e.g., machine learning and audio processing algorithms) to identify the context of the scene (e.g., garage opening, cat being fed cat food, and the like) and/or the location of the sensors 102a, 102b (e.g., a driveway, bedroom, kitchen of a house, and/or the like). For example, the context data may be determined based on the video data. The context data may also be determined based on the audio data. For example, the determination of context data may include object recognition, such as recognizing the presence of a baby, a baby stroller, a pet, a cooktop range in a kitchen, a file cabinet, and/or the like. For example, the context data may be determined based on machine learning algorithms executed using audio events of interest and detected objects of interest, as well as associated audio samples and video frames. The machine learning algorithms also may use other device data such as data from a depth camera, temperature sensor, light sensor, and the like. For example, the machine learning algorithms may be used to determine objects in a scene. The objects in a scene may be assigned a semantic classifier (e.g., family member, counter, glass door, etc.) based on the audio data and/or video data. The computing device may determine the confidence level of a classification of the audio event of interest based on the location and the context data. The confidence level may be indicative of the accuracy of the preliminary confidence level. The computing device may determine context information based on various audio events of interest and recognized objects. For example, the computing device may determine a long term context based on the received audio data and the received video data.

As a further example, the computing device may detect changes in the context information, such as a change in the context of the audio event of interest. The context data may comprise information indicative of at least one of: an identity of an object, a type of activity, distance information, scene classification, time information, or a historical trend. The context data may be sent to a database or a notification server such as the notification module 208. The computing device may determine, based on the video data, an object associated with the audio event. The determination of the context data may be based on the object. Objects of interest may be visually recognized via a convolution operation or R-CNN operation, for example. For example, the object of interest may be an object associated with an audio event of interest. The computing device may determine a source of audio present in the received audio data.

At step 410, the computing device may adjust the confidence level. The confidence level may be adjusted based on the location of the at least one device. For example, adjusting the confidence level may comprise decreasing the confidence level based on a logical relationship between the location and the audio event. For example, adjusting the confidence level may comprise increasing the confidence level based on the logical relationship between the location and the audio event. For example, adjusting the confidence level may comprise decreasing, based on an absence of a logical relationship between the location and the audio event, the confidence level. For example, adjusting the confidence level may comprise increasing, based on a presence of a logical relationship between the location and the audio event, the confidence level. For example, adjusting the confidence level may comprise decreasing, based on the context data not being indicative of an object that originates a sound corresponding to the audio event, the confidence level. For example, adjusting the confidence level may comprise increasing, based on the context data being indicative of an object that originates a sound corresponding to the audio event, the confidence level.

At step 412, the computing device may cause a notification to be sent. The notification can be caused to be sent based on the confidence level satisfying a threshold and the context data. A notification may be generated based on the confidence level. Context information can be sent to a notification server such as the notification module 208. For example, causing, based on the confidence level satisfying a threshold and the context data, a notification associated with the audio event to be sent may comprise sending the context data and the adjusted confidence level to a notification server. The notification module 208 may send the notification to a user or a user device such as the user device 108. For example, notifications can be sent based on comparison to the context detection threshold, a relevancy threshold, and/or the location of at least one of the sensors 102a, 102b. The notification module 208 may determine whether the context data is relevant to the audio event, such as based on a comparison to the relevancy threshold. As another example, notifications can be sent based on preferences specified by the user via the user device 108.

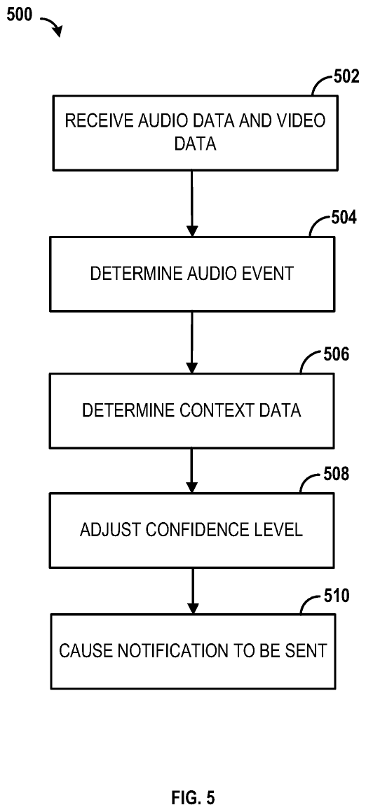

FIG. 5 shows a flowchart illustrating an example method 500 for intelligent audio event detection. The method 500 may be implemented using the devices shown in FIGS. 1-3. For example, the method 500 may be implemented using a context server such as the context module 206. At step 502, a computing device may receive audio data and video data. The audio data and video data may be received from at least one device. For example, the audio data may be received from an audio device such as the audio sensor 102a. As another example, the video data may be received from a video device such as the video sensor 102b. In this connection, video frames having recognized or detected objects may be received. Generally, the at least one device may comprise at least one of: of a microphone or camera. The audio data and video data may each be associated with a scene sensed by the at least one sensor. At step 504, the computing device may determine an audio event. The determination of the audio event may be based on the audio data and/or the video data. For example, the audio event may be classified based on audio feature extraction for sound classification and/or object recognition from the video data. The audio event may be determined with audio data alone. The audio event may be determined and analyzed based on audio data and video data together. For example, the video data may indicate the presence of a sleeping baby in a baby room via object detection and the audio data may indicate a dog barking audio event. The indication of the presence of the baby may be used as context information to determine that the dog barking noise is probably a false positive because it is unlikely that a dog would be present in the same room as a sleeping baby. The audio event may be associated with a confidence level. The computing device may determine a time corresponding to the audio event. The computing device may determine a likelihood that the audio event of interest corresponds to a sound associated with the location. For example, the audio event of interest may be determined by an analysis module such as the analysis module 202 via performance of audio signal processing and machine learning algorithms. Determined properties, patterns, classifications, correlations, and the like of extracted audio features may be determined.

At step 506, the computing device may determine context data associated with the audio event of interest. For example, the computing device may be a context module 206 that may perform various algorithms to determine the context data. The context module 206 may perform various algorithms (e.g., machine learning and audio processing algorithms) to identify the context of the scene (e.g., garage opening, cat being fed cat food, and the like) and/or the location of the sensors 102a, 102b (e.g., a driveway, bedroom, kitchen of a house, and/or the like). For example, the context data may be determined based on the video data. The context data may also be determined based on the audio data. For example, the determination of context data may include object recognition, such as recognizing the presence of a baby, a baby stroller, a pet, a cooktop range in a kitchen, a file cabinet, and/or the like. For example, the context data may be determined based on machine learning algorithms executed using audio events of interest and detected objects of interest, as well as associated audio samples and video frames. The machine learning algorithms also may use other device data such as data from a depth camera, temperature sensor, light sensor, and the like. This way, the context data may be determined based on other sensor data such as data from a depth camera, temperature sensor, light sensor, and the like. For example, the machine learning algorithms may be used to determine objects in a scene. The objects in a scene may be assigned a semantic classifier (e.g., family member, counter, glass door, etc.) based on the audio data and/or video data. The context data may comprise a location of at least one device associated with at least one of: the audio data or the video data. The location may be associated with the audio event. The computing device may determine the confidence level of a classification of the audio event of interest based on the location and the context data. The confidence level may be indicative of the accuracy of a preliminary confidence level. The computing device may determine context information based on various audio events of interest and recognized objects. For example, the computing device may determine a long term context based on the received audio data and the received video data.

As a further example, an initial audio classification such as an audio classification at the preliminary confidence level may be received by the computing device. The computing device may analyze the preliminary confidence level to assess that the audio event of interest is accurately classified to a threshold. The preliminary confidence level may be a classification made by the sensors 102a, 102b. As a further example, the threshold may be a context detection threshold, which may be based on the context data and be dynamically set. The comparison may be used to adjust the preliminary confidence level or for the computing device to determine the confidence level (e.g., without calculation of a preliminary confidence level). The preliminary confidence level and/or the confidence level may be determined based on a machine learning algorithm.

As a further example, the computing device may detect changes in the context information, such as a change in the context of the audio event of interest. Also, the computing device may receive an indication of a change in context of the audio event of interest. The context data may comprise information indicative of at least one of: an identity of an object, a type of activity, distance information, scene classification, time information, or a historical trend. The context data may comprise the context of the audio event of interest and/or the context of a scene, field of view, ROI associated with the audio event of interest. The context data may be sent to a database or a notification server such as the notification module 208. The computing device may determine, based on the video data, an object associated with the audio event. The determination of the context data may be based on the object. Objects of interest may be visually recognized via a convolution operation or R-CNN operation, for example. For example, the object of interest may be an object associated with an audio event of interest. The computing device may determine a source of audio present in the received audio data.

At step 508, the computing device may adjust the confidence level. The confidence level may be adjusted based on the location of the at least one device. For example, adjusting the confidence level may comprise decreasing the confidence level based on a logical relationship between the location and the audio event. As an example, adjusting the confidence level may comprise increasing the confidence level based on the logical relationship between the location and the audio event. For example, adjusting the confidence level may comprise decreasing, based on the context data not being indicative of an object that originates a sound corresponding to the audio event, the confidence level. For example, adjusting the confidence level may comprise increasing, based on the context data being indicative of an object that originates a sound corresponding to the audio event, the confidence level. At step 510, the computing device may cause a notification to be sent. The notification can be caused to be sent based on the confidence level satisfying a threshold and the context data. A notification may be generated based on the confidence level. Context information can be sent to a notification server such as the notification module 208. For example, causing, based on the confidence level satisfying a threshold and the context data, a notification associated with the audio event to be sent may comprise sending the context data and the adjusted confidence level to a notification server. The notification module 208 may send the notification to a user or a user device such as the user device 108. For example, notifications can be sent based on comparison to the context detection threshold, a relevancy threshold, and/or the location of at least one of the sensors 102a, 102b. The notification module 208 may determine whether the context data is relevant to the audio event, such as based on a comparison to the relevancy threshold. As another example, notifications can be sent based on preferences specified by the user via the user device 108.

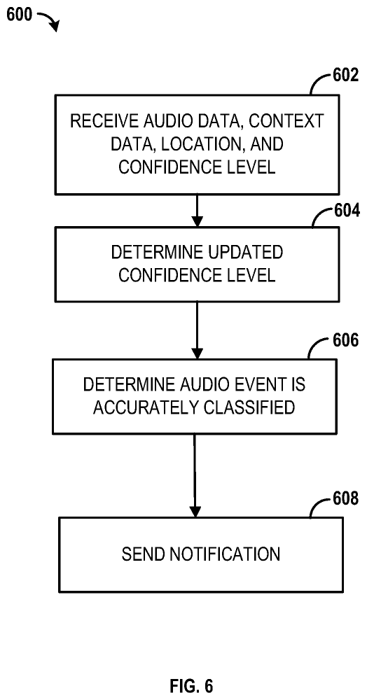

FIG. 6 shows a flowchart illustrating an example method 600 for intelligent audio event detection. The method 600 may be implemented using the devices shown in FIGS. 1-3. For example, the method 600 may be implemented using a notification server such as the notification module 208. At step 602, a computing device may receive audio data comprising an audio event, context data based on video data associated with audio event, a location of at least one device, and a confidence level associated with the audio event. For example, the audio data may include audio features that may be determined by the at least one device. Generally, the at least one device may comprise at least one of: a microphone or camera. In particular, the audio data may be received from an audio device such as the audio sensor 102a. As an example, audio features of interest within the audio data may be determined by an analysis module such as the analysis module 202 via performance of audio signal processing and machine learning algorithms. Determined properties, patterns, classifications, and correlations of extracted audio features may be received by the computing device. As an example, an initial audio classification such as an audio classification at a preliminary confidence level or the confidence level may be received by the computing device. The computing device may instead determine the confidence level. The computing device may request and/or retrieve a file from a database, such as to facilitate audio feature extraction, video frame analysis, execution of a machine learning algorithm, and the like.

For example, the context data may comprise the location of the at least one device 26141.0362U1 associated with at least one of: the audio data or video data. For example, the computing device may be a context module 206 that may perform various algorithms to determine the context data. The context module 206 may perform various algorithms (e.g., machine learning and audio processing algorithms) to identify the context of the scene (e.g., garage opening, cat being fed cat food, and the like) and/or the location of the sensors 102a, 102b (e.g., a driveway, bedroom, kitchen of a house, and/or the like). For example, the determination of context data may include object recognition, such as recognizing the presence of a baby, a baby stroller, a pet, a cooktop range in a kitchen, a file cabinet, and/or the like. For example, the machine learning algorithms may be used to determine objects in a scene. The objects in a scene may be assigned a semantic classifier (e.g., family member, counter, glass door, etc.) based on the audio data and/or video data. The location may be associated with the audio event. The audio event may be determined based on the audio data and/or video data. For example, the audio event may be classified based on audio feature extraction for sound classification and/or object recognition from the video data. The audio event may be determined with audio data alone. The audio event may be determined and analyzed based on audio data and video data together. For example, the video data may indicate the presence of a sleeping baby in a baby room via object detection and the audio data may indicate a dog barking audio event. The indication of the presence of the baby may be used as context information to determine that the dog barking noise is probably a false positive because it is unlikely that a dog would be present in the same room as a sleeping baby.

At step 604, the computing device may determine an updated confidence level (e.g., updated from the confidence level or the preliminary confidence level). The updated confidence level may be determined based on the location and the context data. The determination of the updated confidence level may comprise determining an adjustment to the confidence level based on the location of the at least one device and/or a machine learning algorithm. For example, the computing device may perform adjusting the confidence level. For example, adjusting the confidence level may comprise decreasing the confidence level based on a logical relationship between the location and the audio event. For example, adjusting the confidence level may comprise increasing the confidence level based on the logical relationship between the location and the audio event. For example, adjusting the confidence level may comprise decreasing, based on an absence of a logical relationship between the location and the audio event, the confidence level. For example, adjusting the confidence level may comprise increasing, based on a presence of a logical relationship between the location and the audio event, the confidence level. For example, adjusting the confidence level may comprise decreasing, based on the context data not being indicative of an object that originates a sound corresponding to the audio event, the confidence level. For example, adjusting the confidence level may comprise increasing, based on the context data being indicative of an object that originates a sound corresponding to the audio event, the confidence level.

The context data may comprise a location of at least one device associated with at least one of: the audio data or video data. The video data may be received from a video device such as the video sensor 102b. In this connection, video frames having recognized or detected objects may be received. For example, the video data may be sent to a remote computer device. For example, the video data may comprise video frames containing objects of interest that have been detected or recognized. Objects can be recognized via a convolution operation, Region based Convolutional Neural Network (R-CNN) operation, or the like, for example. The computing device may send distance data from a depth camera (e.g., RGB-D sensor, LIDAR sensor, or a radar sensor). For example, the computing device or a remote computing device may determine the location of the at least one device based on this distance data.

For example, the computing device may determine a location label of the at least one device during set up of the at least one device. The at least one sensor may be associated with at least one of: the audio data or the video data. The location may comprise a location of at least one of the sensors 102a, 102b. For another example, the location may be indicated by at least one of: GPS coordinates, a geographical region, or a location label. As another example, the location may be determined based on device data, machine learning classifiers, neural networks, and the like. The context data may be determined based on the video data, for example. The context data may also be determined based on the audio data. For example, the context data may be determined based on machine learning algorithms executed using audio events of interest and detected objects of interest, as well as associated audio samples and video frames. The machine learning algorithms also may use other device data such as data from a depth camera, temperature sensor, light sensor, and the like. The context data may comprise information indicative of at least one of: an identity of an object, a type of activity, distance information, scene classification, time information, or a historical trend. The context data may be received by the computing device.

At step 606, the computing device may determine that the audio event is accurately classified. For example, the determination that the audio event is accurately classified may comprise a determination that the context data matches the audio event. The determination of accurate classification may be based on the location and the updated confidence level satisfying a threshold. For example, the audio event of interest may be determined based on at least one of: audio features and the video data. The threshold may be a context detection threshold, a relevancy threshold, or the like. The location of the at least one device may be part of context information or metadata used to set the context detection threshold. The audio event may be classified as a type of audio event, such as dog barking, baby crying, garage door opening and the like. The computing device may classify the audio of interest based on an audio processing algorithm and/or a machine learning algorithm. As another example, the confidence level may be indicative of the accuracy of the preliminary confidence level. The preliminary confidence level may be a classification made by an analysis module such as the analysis module 202. As another example, the confidence level may be adjusted based on a context detection threshold or a relevancy threshold via a machine learning algorithm. The confidence level may be adjusted based on the location of the at least one device. For example, adjusting the confidence level may comprise decreasing the confidence level based on a logical relationship between the location and the audio event. As another example, adjusting the confidence level may comprise increasing the confidence level based on the logical relationship between the location and the audio event.

Context information may be determined based on various audio events of interest and recognized objects. For example, long term context may be determined based on the received audio data and the received video data. Long term context information, such as the people who typically appear in a monitored scene (e.g., a family member in a room of the family's residence), may be determined. For example, the long term context information may be determined based on the audio data, video data, distance data, and other data received from the sensors 102a, 102b. Long term context information may involve determination of historical trends, such as the number of times a baby cries or the frequency of turning on lights, for example.

As a further example, changes in the context information, such as a change in the context of the audio event of interest, may be detected. The context data may comprise information indicative of one or more of an identity of an object, a type of activity, distance information, scene classification, time information, or a historical trend. The context data may be sent to a database or a notification server such as the notification module 208. An object associated with the audio event may be determined based on the video data. The determination of the context data may be based on the object. Objects of interest may be visually recognized via a convolution operation or R-CNN operation, for example. For example, the object of interest may be an object associated with an audio event of interest. As another example, a source of audio present in the received audio data may be determined. The location of the at least one sensor may be determined or received by the computing device. For example, a location label of the at least one sensor may be determined or received during set up of the at least one sensor The location may comprise a location of one or more of the sensors 102a, 102b.

At step 608, the computing device may send a notification of the audio event to a user. The notification may be sent based on the accurate classification and the context data. For example, the notification may be sent based on the confidence level satisfying a threshold and the context data. A notification may be generated based on the confidence level by the computing device. For example, a notification may be generated by the notification module 208. For example, causing, based on the confidence level satisfying a threshold and the context data, a notification associated with the audio event to be sent may comprise sending the context data and the adjusted confidence level to a notification server. The notification module 208 may send the notification to a user. The notification module 208 may send the notification to a user or a user device such as the user device 108. For example, notifications can be sent based on comparison to the context detection threshold, a relevancy threshold, and/or the location of one or more of the sensors 102a, 102b. The notification module 208 may determine whether the context data is relevant to the audio event, such as based on a comparison to the relevancy threshold. As another example, notifications can be sent based on preferences specified by the user via the user device 108.

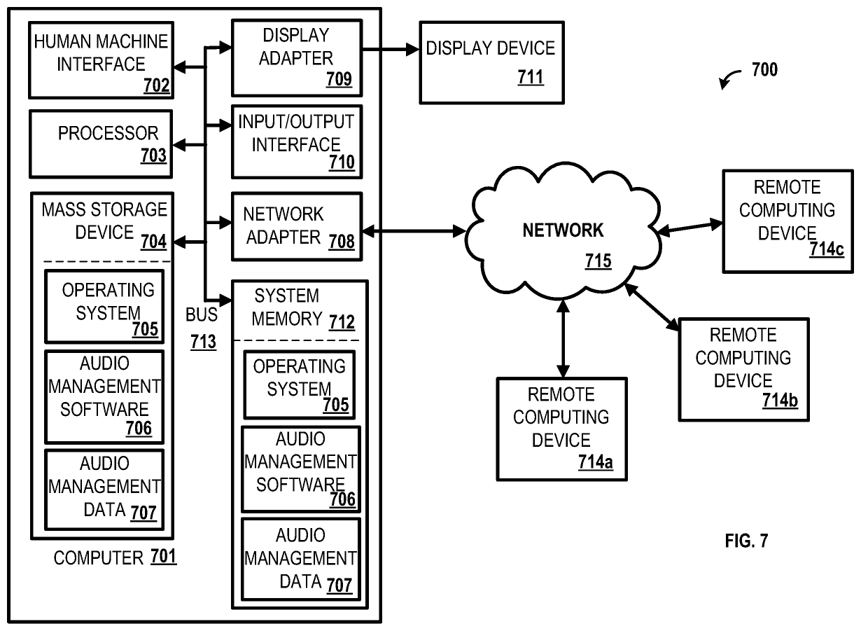

In an exemplary aspect, the methods and systems may be implemented on a computer 701 as illustrated in FIG. 7 and described below. Similarly, the methods and systems disclosed may utilize one or more computers to perform one or more functions in one or more locations. FIG. 7 shows a block diagram illustrating an exemplary operating environment 700 for performing the disclosed methods. This exemplary operating environment 700 is only an example of an operating environment and is not intended to suggest any limitation as to the scope of use or functionality of operating environment architecture. Neither should the operating environment 700 be interpreted as having any dependency or requirement relating to any one or combination of components illustrated in the exemplary operating environment 700.

The present methods and systems may be operational with numerous other general purpose or special purpose computing system environments or configurations. Examples of well-known computing systems, environments, and/or configurations that may be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems may be performed by software components. The disclosed systems and methods may be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods may also be practiced in grid-based and distributed computing environments where tasks are performed by remote processing devices that are linked through a communications network. In a distributed computing environment, program modules may be located in local and/or remote computer storage media including memory storage devices.

The sensors 102a, 102b , the computing device 106, and/or the user device 108 of

FIGS. 1-3 may be or include a computer 701 as shown in the block diagram 600 of FIG. 7. The computer 701 may include one or more processors 703, a system memory 712, and a bus 713 that couples various system components including the one or more processors 703 to the system memory 712. In the case of multiple processors 703, the computer 701 may utilize parallel computing. The bus 713 is one or more of several possible types of bus structures, including a memory bus or memory controller, a peripheral bus, an accelerated graphics port, or local bus using any of a variety of bus architectures.

The computer 701 may operate on and/or include a variety of computer readable media (e.g., non-transitory). The readable media may be any available media that is accessible by the computer 701 and may include both volatile and non-volatile media, removable and non-removable media. The system memory 712 has computer readable media in the form of volatile memory, such as random access memory (RAM), and/or non-volatile memory, such as read only memory (ROM). The system memory 712 may store data such as the audio management data 707 and/or program modules such as the operating system 705 and the audio management software 706 that are accessible to and/or are operated on by the one or more processors 703.

The computer 701 may also have other removable/non-removable, volatile/non-volatile computer storage media. FIG. 7 shows the mass storage device 704 which may provide non-volatile storage of computer code, computer readable instructions, data structures, program modules, and other data for the computer 701. The mass storage device 704 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any quantity of program modules may be stored on the mass storage device 704, such as the operating system 705 and the audio management software 706. Each of the operating system 705 and the audio management software 706 (or some combination thereof) may include elements of the program modules and the audio management software 706. The audio management software 706 may include audio processing and machine learning algorithms to identify an audio event of interest and interpret the audio event (e.g., its classification) based on location of the sensor(s) detecting the audio event, context, and relevancy. The audio management software 706 may include consideration of other types of sensor data described herein such as video data, distance/depth data, temperature data and the like. The audio management data 707 may also be stored on the mass storage device 704. The audio management data 707 may be stored in any of one or more databases known in the art. Such databases may be DB2®, Microsoft® Access, Microsoft® SQL Server, Oracle®, MySQL, PostgreSQL, and the like. The databases may be centralized or distributed across locations within the network 715. The audio management data 707 may include other types of sensor data described herein such as video data, distance/depth data, temperature data and the like.

A user may enter commands and information into the computer 701 via an input device (not shown). Examples of such input devices include, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 703 via a human machine interface 702 that is coupled to the bus 713, but may be connected by other interface and bus structures, such as a parallel port, game port, an IEEE 1394 Port (also known as a Firewire port), a serial port, network adapter 708, and/or a universal serial bus (USB).

The display device 711 may also be connected to the bus 713 via an interface, such as the display adapter 709. It is contemplated that the computer 701 may include more than one display adapter 709 and the computer 701 may include more than one display device 711. The display device 711 may be a monitor, an LCD (Liquid Crystal Display), light emitting diode (LED) display, television, smart lens, smart glass, and/or a projector. In addition to the display device 711, other output peripheral devices may be components such as speakers (not shown) and a printer (not shown) which may be connected to the computer 701 via the Input/Output Interface 710. Any step and/or result of the methods may be output (or caused to be output) in any form to an output device. Such output may be any form of visual representation, including, but not limited to, textual, graphical, animation, audio, tactile, and the like. The display device 711 and computer 701 may be part of one device, or separate devices.

The computer 701 may operate in a networked environment using logical connections to one or more remote computing devices 714a, 714b, 714c. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 701 and a remote computing device 714a, 714b, 714c may be made via a network 715, such as a local area network (LAN) and/or a general wide area network (WAN). Such network connections may be through the network adapter 708. The network adapter 708 may be implemented in both wired and wireless environments. Such networking environments are conventional and commonplace in dwellings, offices, enterprise-wide computer networks, intranets, and the Internet.

Application programs and other executable program components such as the operating system 705 are shown herein as discrete blocks, although it is recognized that such programs and components reside at various times in different storage components of the computing device 701, and are executed by the one or more processors 703 of the computer. An implementation of the audio management software 706 may be stored on or sent across some form of computer readable media. Any of the described methods may be performed by processor-executable instructions embodied on computer readable media.

For purposes of illustration, application programs and other executable program components such as the operating system 705 are illustrated herein as discrete blocks, although it is recognized that such programs and components may reside at various times in different storage components of the computing device 701, and are executed by the one or more processors 703 of the computer 701. An implementation of audio management software 706 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

While the methods and systems have been described in connection with specific examples, it is not intended that the scope be limited to the particular embodiments set forth, as the embodiments herein are intended in all respects to be illustrative rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other embodiments will be apparent to those skilled in the art from consideration of the specification and practice described herein. It is intended that the specification and examples be considered as exemplary only, with a true scope and spirit being indicated by the following claims.

What is claimed is:

1. A method comprising:
receiving audio data and video data;
determining a location of at least one device associated with one or more of the audio data or the video data;
determining, based on the audio data, an audio event, wherein the audio event is associated with a confidence level;
determining, based on the video data, context data associated with the audio event;
determining, based on the location and the context data, an updated confidence level; and
causing, based on the updated confidence level satisfying a threshold, a notification associated with the audio event to be sent.

2. The method of claim 1, further comprising receiving, from a remote device, the audio event and the confidence level.

3. The method of claim 1, further comprising determining, based on the video data, an object associated with the audio event, wherein the determination of the context data is based on the object.

4. The method of claim 1, further comprising detecting a change in the context data of the audio event, wherein the context data comprises information indicative of at least one of: an identity of an object, a type of activity, distance information, scene classification, time information, a time of the audio event, a volume of the audio event, or a historical trend.

5. The method of claim 1, further comprising receiving, from at least one of: a Red Green Blue Depth (RGB-D) device, a Light Detection and Ranging (LIDAR) device, or a Radio Detection and Ranging (RADAR) device, distance data, wherein the location is determined based on the distance data.

6. The method of claim 1, further comprising determining at least one of: a time corresponding to the audio event, a likelihood that the audio event corresponds to a sound associated with the location, or a long term context.

7. The method of claim 1, wherein causing, based on the confidence level satisfying a threshold and the context data, a notification associated with the audio event to be sent comprises sending the context data and the adjusted confidence level to a notification server.

8. The method of claim 1, further comprising determining at least one of: a source of audio present in the audio data or a location label of the at least one device during set up of the at least one device.

9. The method of claim 1, wherein adjusting the confidence level comprises decreasing the confidence level based on a logical relationship between the location and the audio event or increasing the confidence level based on the logical relationship between the location and the audio event.

10. The method of claim 1, wherein adjusting the confidence level comprises:
decreasing, based on an absence of a logical relationship between the location and the audio event, the confidence level; and
increasing, based on a presence of a logical relationship between the location and the audio event, the confidence level.

11. The method of claim 1, wherein adjusting the confidence level comprises:
decreasing, based on the context data not being indicative of an object that originates a sound corresponding to the audio event, the confidence level;
increasing, based on the context data being indicative of an object that originates a sound corresponding to the audio event, the confidence level.

12. A method comprising:
receiving audio data and video data;
determining, based on the audio data, an audio event, wherein the audio event is associated with a confidence level;
determining, based on the video data, context data associated with the audio event, wherein the context data comprises a location of at least one device associated with at least one of: the audio data or the video data, and wherein the location is associated with the audio event;
adjusting, based on the location, the confidence level; and
causing, based on the confidence level satisfying a threshold and the context data, a notification associated with the audio event to be sent.

13. The method of claim 12, further comprising detecting a change in the context data of the audio event, wherein the context data comprises information indicative of at least one of: an identity of an object, a type of activity, distance information, scene classification, time information, a time of the audio event, a volume of the audio event, or a historical trend.

14. The method of claim 12, further comprising determining a time corresponding to the audio event.

15. The method of claim 12, further comprising determining at least one of: a likelihood that the audio event corresponds to a sound associated with the location, a long term context, or a source of audio present in the audio data.

16. The method of claim 12, wherein adjusting, based on the location, the confidence level comprises decreasing the confidence level based on a logical relationship between the location and the audio event or increasing the confidence level based on the logical relationship between the location and the audio event.

17. The method of claim 12, wherein adjusting the confidence level comprises:
decreasing, based on an absence of a logical relationship between the location and the audio event, the confidence level; and
increasing, based on a presence of a logical relationship between the location and the audio event, the confidence level.

18. The method of claim 12, wherein adjusting the confidence level comprises:
decreasing, based on the context data not being indicative of an object that originates a sound corresponding to the audio event, the confidence level;
increasing, based on the context data being indicative of an object that originates a sound corresponding to the audio event, the confidence level.

19. A method comprising:
receiving audio data comprising an audio event, context data based on video data associated with the audio event, a location of at least one device associated with at least one of: the audio data or the video data, and a confidence level associated with the audio event,
determining, based on the location and the context data, an updated confidence level;
determining, based on the updated confidence level satisfying a threshold, that the audio event is accurately classified; and
sending, based on the context data and based on determining that the audio event is accurately classified, a notification of the audio event to a user.

20. The method of claim 19, further comprising determining that the context data is relevant to the audio event and wherein the context data comprises information indicative of at least one of: an identity of an object, a type of activity, distance information, scene classification, time information, a time of the audio event, a volume of the audio event, or a historical trend.

21. The method of claim 19, wherein determining the updated confidence level is based on a machine learning algorithm.

22. The method of claim 19, wherein determining the updated confidence level comprises decreasing the confidence level based on a logical relationship between the location and the audio event or increasing the confidence level based on the logical relationship between the location and the audio event.

23. The method of claim 19, wherein determining the updated confidence level comprises:
decreasing, based on an absence of a logical relationship between the location and the audio event, the confidence level; and
increasing, based on a presence of a logical relationship between the location and the audio event, the confidence level.

24. The method of claim 19, wherein determining the updated confidence level comprises:
decreasing, based on the context data not being indicative of an object that originates a sound corresponding to the audio event, the confidence level;
increasing, based on the context data being indicative of an object that originates a sound corresponding to the audio event, the confidence level.

25. The method of claim 19, wherein the audio data and the video data are each associated with a scene sensed by the at least one device.

26. The method of claim 19, wherein the location is indicated by at least one of: GPS coordinates, a geographical region, or a location label.

27. The method of claim 19, wherein determining that the audio event is accurately classified comprises determining that the context data matches the audio event.
